(19) United States
(12) Patent Application Publication
(10) Pub. No.: US 2026/0205441 A1
(43) Pub. Date: Jul. 16, 2026

(54) DYNAMIC POLICY-BASED ROUTING DURING SESSION RUNTIME

(71) Applicant: Cisco Technology, Inc., San Jose, CA (US)

(72) Inventors: Vincent E. Parla, North Hampton, NH (US); Lucas Siba, Langley (CA); Danxiang Li, Arlington, MA (US)

(21) Appl. No.: 19/169,880

(22) Filed: Apr. 3, 2025

Related U.S. Application Data
(60) Provisional application No. 63/745,091, filed on Jan. 14, 2025.

(51) Int. Cl. H04L 9/40

(52) U.S. Cl. CPC H04L 63/029; H04L 63/0236; H04L 63/20

(57) ABSTRACT

Techniques for dynamic policy-based routing of network traffic through a split-tunnel system after session establishment and during session runtime of a secure access connection. After a secure access connection has been established by an endpoint device, processes running on the endpoint device may attempt to send traffic to a destination by generating a Domain Name Service (DNS) request. According to the techniques described herein, a capture component running in the kernel may intercept the DNS requests (and new connections/sockets) as they are being created by processes. The capture component may instead route the DNS requests to a policy engine that applies various DNS and domain-level policy to the DNS request and returns a verdict back to the endpoint device. Using dynamic, real-time policy-based routing of traffic allows for adaptation to new security threats or changing network conditions without having to update static policies on each endpoint device.

### RELATED APPLICATIONS

This patent application is a continuation of and claims priority to U.S. Provisional Patent Application No. 63/745,091 , filed Jan. 14, 2025, which is fully incorporated herein by reference

### TECHNICAL FIELD

The present disclosure relates generally to perform dynamic policy-based routing for traffic through a split-tunnel system.

### BACKGROUND

Traditionally, secure access solutions, such as Virtual Private Networks (VPNs), Zero Trust Network Access (ZTNA), and security meshes, are designed to enforce access control and encrypt communications between endpoint devices and network resources. These solutions rely on predefined policies that dictate how traffic is handled, including whether it is tunneled through a security appliance or routed directly to the internet. These technologies establish static traffic routing policies at the time of session initiation, but once a session is established, traffic steering decisions remain fixed and cannot adapt to changing conditions such as device security posture, application state, or compliance status.

For example, if a system falls out of compliance due to an outdated browser, a traditional VPN or ZTNA solution lacks the capability to dynamically redirect traffic from that browser to a security appliance or cloud-based security service. As another example, when a user accesses a known trusted Software-as-a-Service (SaaS) service or a personal banking website, existing secure access solutions do not have the ability to adjust routing decisions, regardless of contextual security policies. Some existing technologies, such as Dynamic Split Tunneling (DST) in VPN clients, allow for predefined rules to steer traffic inside or outside of a secure tunnel. However, these rules are also static and determined at tunnel establishment time, and they do not allow for real-time, dynamic modifications based on evolving security policies, user behavior, or device posture assessments.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram in which devices perform dynamic policy-based routing of network traffic during session runtime.

FIG. 2 illustrates a component diagram of example components of an endpoint device as described herein.

FIGS. 3A and 3B collectively illustrate a sequence diagram of techniques described herein for DNS request capture and performing dynamic policy-based routing of network traffic during session runtime.

FIG. 4 illustrates a flowchart depicting a method 400 for performing dynamic policy-based routing of network traffic of a malicious process during session runtime.

FIG. 5 illustrates a flow diagram of an example method for intercepting DNS requests to perform dynamic policy-based routing of network traffic during session runtime.

FIG. 6 illustrates a flow diagram of an example method for identifying L3 or L4 connections being created on an endpoint device and performing dynamic policy-based routing of network traffic during session runtime.

FIG. 7 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes techniques for dynamic policy-based routing of network traffic during session runtime.

The techniques described herein may include a first method is performed by an endpoint device configured to perform dynamic policy-based routing for traffic through a split-tunnel system. The first method may include configuring the split-tunnel system by establishing a first connection that routes traffic directly to a public network and a second connection that routes traffic through a secure tunnel. Further, the first method may include capturing a Domain Name Service (DNS) request originating on the endpoint device prior to the DNS request being sent to a DNS resolver, the DNS request being associated with a destination to which the endpoint device is requesting to send traffic. The first method may include sending the DNS request to a DNS policy engine that is remote from the endpoint device, receiving, from the DNS policy engine, a verdict regarding the DNS request that indicates a routing operation for the endpoint device to perform with respect to the traffic, and performing the routing operation on the traffic.

The techniques described herein may additionally, or alternatively, include a second method that comprises configuring, at an endpoint device, a split-tunnel system by establishing a first connection that routes traffic directly to a public network and a second connection that routes traffic through a secure tunnel. The second method may further include determining that a Layer 3 (L3) or Layer (L4) connection is being created on the endpoint device, and sending a query to a policy engine that is remote from the endpoint device, the query indicating a request for a verdict regarding a destination of the L3 or L4 connection. Additionally, the second method may include receiving, from the policy engine, the verdict regarding the destination of the L3 or L4 connection that indicates a routing operation for the endpoint device to perform with respect to the traffic, and performing the routing operation on the traffic.

Additionally, the techniques described herein may be performed by a system and/or device having non-transitory computer-readable media storing computer-executable instructions that, when executed by one or more processors, performs the method described above.

### Example Embodiments

Traditionally, overlay technologies have relied on predefined routing policies that dictate how traffic is handled, including whether it is tunneled through a security appliance or routed directly to the internet. These technologies establish static traffic routing policies at the time of session initiation, but once a session is established, traffic steering decisions remain fixed and cannot adapt to changing conditions such as device security posture, application state, or compliance status. This can be problematic for security reasons for these overlay sessions, particularly long-running overlay sessions, due to the dynamic nature of security threats.

In some instances, the endpoint device is configured with a split-tunnel system where the device establishes at least two distinct connections: a first connection that routes traffic directly to a public network, and a second connection that routes traffic through a secure tunnel. This configuration allows for flexible traffic management based on security policies and network conditions.

This disclosure describes techniques for dynamic policy-based routing of network traffic through a split-tunnel system after session establishment and during session runtime of a secure access connection. After a secure access connection has been established (e.g., VPN, ZTNA, security mesh, etc.) by an endpoint device, processes running on the endpoint device may attempt to send traffic to a destination by generating a Domain Name Service (DNS) request. Traditionally, the Operating System (OS) of the endpoint device would perform various techniques to help resolve the DNS request into a destination Internet Protocol (IP) address for the processes, and the traffic destined for the destination IP address would be routed according to the static routing policies received at the endpoint device at session establishment. According to the techniques described herein, a capture component running in the kernel may intercept the DNS requests (and new connections/sockets) as they are being created by processes. The capture component may instead route the DNS requests to a policy engine (e.g., cloud-based policy service) that applies various DNS and domain-level policy to the DNS request and returns a verdict back to the endpoint device.

In some instances, the verdict may simply be “block” such that the traffic is not allowed to be communicated to the destination (e.g., a failing DNS response is returned to the endpoint device). In other examples, however, the verdict may be “allow” and the traffic may be routed according to the routing policies of the OS of the endpoint device, or the verdict may be “proxy” where the traffic is to be routed through the secure overlay session to a security proxy for further inspection. In some instances, the proxy verdict may further include metadata for selecting a proxy server to enable load balancing or the usage of an on-premises proxy server to access on-premises resources.

The endpoint device would use the verdict to make routing decisions for the traffic at hand, and may further cache the verdict locally and return a falsified or synthetic IP address for the DNS request. As new connections or sockets attempt to use that synthetic IP, the endpoint device could then allow, block, or proxy the traffic into the secure overlay based on the verdict that was locally cached.

In some instances, the policy engine may determine the verdict strictly based on the domain of the DNS request and security policies created for that domain. For instance, an enterprise or other association associated with the endpoint device may provide security policies for various websites or domains to govern how traffic to the domains is handled. However, in some examples, context data associated with the endpoint device, requesting process, user, etc., may be sent along with the DNS request to the policy engine to determine the verdict. The secure overlay connection generally includes extensive real-time metadata about the state of the endpoint, the user, and the process originating the DNS request. The context may include, for example, application identifiers, OS package names, user identity information, device posture information, to which networks the endpoint device is connected, and so forth.

To provide the additional context or metadata to the policy engine, the endpoint device may utilize various protocols to carry the context. For instance, the client deice may use DNS over Hypertext Transfer Protocol Secure (HTTPS) (DoH), DNS over Transport Layer Security (TLS) (DoT), DNSCrypt, DNS over Quick UDP Internet Connections (QUIC) (DoQ), extension mechanisms over DNS (eDNS), and the like. In an example described with respect to DoH, because DoH encapsulates the DNS queries within HTTPS requests, it allows for the inclusion of HTTP headers which can carry various metadata or context described herein. As another example, DoH operators over HTTPS, which relies on TLS for encryption and authorization, there are certificates involved to verify the identity of the client and the server of the DoH provider. Some DoH resolves may use mutual TLS (mTLS) where the endpoint device presents certificates containing context such as device identify or user roles, which may be used to apply policies based on that context. Thus, there are various mechanisms and protocols which may be used to provide context along with the DNS queries for the policy engine to consider.

Once the endpoint device receives a verdict (e.g., allow, block, proxy, etc.), the endpoint device may perform a networking operation based on the verdict. For example, upon receiving an allow verdict, the endpoint device may leave any associated connections to the destination domain untouched and route according to the normal routing policies managed by the OS. Upon receiving a “block” verdict, which may be returned in the form of a failing DNs response to the endpoint device, the endpoint device may refrain from allowing the connections to be established with the destination and may terminate existing connections to the destination. Further, upon receiving a “proxy” verdict, the endpoint device may use a secure overlay session to proxy any associated connections to, for instance, the security proxy for further inspection. In some instances, the proxy verdict may include metadata for selecting a proxy server to enable load balancing or the usage of an on-premises proxy server to access on-premises resources.

Although techniques of this application are described as being implemented by intercepting DNS queries, in some examples, the techniques may include applying policy using networking layer 3 (IPv4 and IPv6) and layer 4 (TCP and UDP) addresses. When the client sees a new TCP or UDP socket being created, it may similarly query the policy engine for a verdict to allow, block, or proxy the socket connection. In some instances, the policy engine could also apply policy using site categorization such as gambling, personal banking, Generative Artificial Intelligence (AI), Data Loss Prevention (DLP), Trusted SaaS, etc. An advantage of the techniques described herein is the traffic may be dynamically steered at access time to be forward to the tunnel/proxy or sent out the public interface . . . or just outright blocked at the endpoint device.

In some instances, the techniques described herein may include selecting between a fleet of proxies (based on policies) to optimally route traffic to the ideal proxy to service that request. For example, if a private resource is in a Data Center 4 (DC 4), the proxy in DC 4 (and on-premises virtual firewall appliance, for example) can be used to provide the best path of access for the user, giving an optimal experience. These additional capabilities may include using a shard technique to select which MASQUE proxy session/tunnel (or other proxying or tunneling technology) the traffic should go over. The methodology can either use a mod algorithm or a route-table/mask algorithm. These techniques may include assigning all traffic that had a value of “0” after mod or mask operations to go over the cloud security service MASQUE proxy session/tunnel (or other proxying or tunneling technology). Then a value on “N>0” would be used to steer traffic down one of the other MASQUE proxy sessions/tunnels (or other proxying or tunneling technologies). For example, a synthetic IP address of 127.128.0.0 would go over the cloud security service MASQUE proxy session/tunnel (or other proxying or tunneling technology), while a resolved synthetic IP address of 127.128.0.1 would go over the first on-prem Secure Appliance MASQUE proxy session/tunnel (or other proxying or tunneling technology) and so forth, up to the number of total proxy nodes in a given configuration. This allows for dynamic routing not only on the endpoint but also across a fleet of Proxy nodes to optimize the routing of proxied (tunneled) traffic.

Further, the endpoint device may incorporate a mechanism for handling static routing policies. During the establishment of the secure tunnel, the endpoint device may receive static routing policies. These policies can be used in conjunction with the dynamic verdicts received from the policy engine. In some cases, the verdict from the policy engine may override the static routing policies, allowing for more flexible and responsive traffic management. The ability to override static routing policies with dynamic verdicts provides a level of adaptability that is crucial in today's rapidly changing network environments. This feature allows organizations to respond quickly to new security threats or changing network conditions without having to update static policies on each endpoint device.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

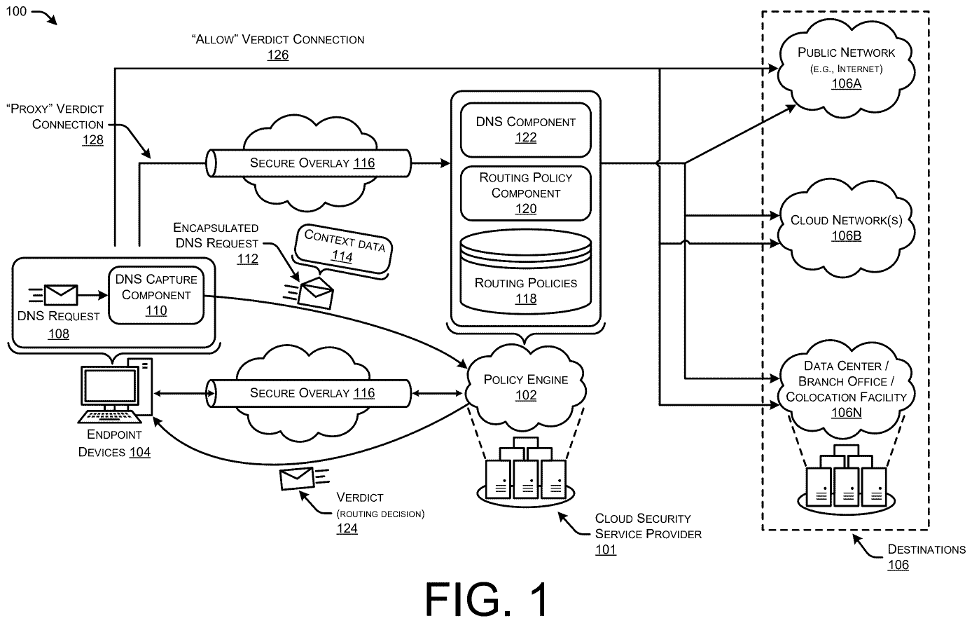

FIG. 1 illustrates a network system 100 for policy-based routing of network traffic. The network system 100 includes a cloud security service provider 101 having a policy engine 102 that manages routing decisions for endpoint devices 104.

The cloud security service provider 101 may be implemented as a cloud-based security service, an on-premises security appliance, or a hybrid solution combining both cloud and on-premises components. It serves as the central hub for managing and enforcing security policies across the network architecture.

The policy engine 102, a key component of the cloud security service provider 101, is responsible for evaluating DNS requests 108 and associated context data 114 to determine appropriate routing decisions. The policy engine 102 may be implemented as a cloud-based service, an on-premises server, or a distributed system combining both cloud and on-premises components.

Endpoint devices 104 represent various types of endpoint devices that connect to the network. These may include, but are not limited to, laptops, desktops, smartphones, tablets, IoT devices, or any network-capable device. Each endpoint device 104 may be configured with a split-tunnel system, establishing at least two distinct connections: one that routes traffic directly to a public network 106A (e.g., allow verdict connection 126), and another that routes traffic through a secure overlay 116 (also referenced to herein as a tunnel) (e.g., proxy verdict connection 128).

The network system 100 enables communication between the endpoint devices 104 and various network destinations 106. These destinations include a public network 106A (e.g., Internet), cloud networks 106B (such as AWS, Azure, or Google Cloud), and a data center/branch office/colocation facility 106N (which could be an on-premises data center, a branch office, or a colocation facility).

After a secure access connection has been established (the secure overlay 116 such as a VPN, ZTNA, security mesh, etc.) by an endpoint device 104, processes running on the endpoint device 104 may attempt to send traffic to a destination 106 by generating a DNS request 108. Traditionally, the OS of the endpoint device 104 would perform various techniques to help resolve the DNS request 108 into a destination IP address for the processes, and the traffic destined for the destination IP address would be routed according to the static routing policies received at the endpoint device 104 at session establishment.

According to the techniques described herein, a DNS capture component 110 running in the kernel may intercept the DNS requests 108 (and new connections/sockets) as they are being created by processes. The DNS capture component 110 may instead route the DNS requests 108 to a policy engine 102 (e.g., cloud-based policy service) that applies various DNS and domain-level policy to the DNS request 108 and returns a verdict 124 back to the endpoint device 104.

In some instances, the verdict 124 may simply be “block” such that the traffic is not allowed to be communicated to the destination 106 (e.g., a failing DNS response is returned to the endpoint device 104). In other examples, however, the verdict 124 may be “allow” and the traffic may be routed according to the routing policies of the OS of the endpoint device 104, or the verdict 124 may be “proxy” where the traffic is to be routed through the secure overlay session to a security proxy for further inspection. In some instances, the verdict 124 may further include metadata for selecting a proxy server to enable load balancing or the usage of an on-premises proxy server to access on-premises resources.

The endpoint device 104 would use the verdict 124 to make routing decisions for the traffic at hand, and may further cache the verdict 124 locally and return a falsified or synthetic IP address for the DNS request 108. As new connections or sockets attempt to use that synthetic IP, the endpoint device 104 could then allow, block, or proxy the traffic into the secure overlay 116 based on the verdict 124 that was locally cached.

In some instances, the policy engine 102 may determine the verdict 124 strictly based on the domain of the DNS request 108 and security policies created for that domain. For instance, an enterprise or other association associated with the endpoint device 104 may provide security policies and/or routing policies 118 for various websites or domains to govern how traffic to the domains is handled. However, in some examples, context data 114 associated with the endpoint device 104, requesting process, user, etc., may be sent along with the DNS request 108 to the policy engine 102 to determine the verdict 124. The secure overlay 116 connection generally includes extensive real-time metadata about the state of the endpoint device 104, a user associated with the endpoint device 104, and the process originating the DNS request 108. The context may include, for example, application identifiers, OS package names, user identity information, device posture information, to which networks the endpoint device 104 is connected, and so forth.

To provide the additional context data 114 or metadata to the policy engine 102, the endpoint device 104 may utilize various protocols to carry the context data 114 by encapsulating the DNS requests 108 to generate an encapsulated DNS request 112. For instance, the client deice may use DoH, DoT, DNSCrypt, DoQ, and the like. In an example described with respect to DoH, because DoH encapsulates the DNS requests 108 within HTTPS requests to generate the encapsulated DNS request 112, it allows for the inclusion of HTTP headers which can carry various metadata or context data 114 described herein. As another example, DoH operators over HTTPS, which relies on TLS for encryption and authorization, there are certificates involved to verify the identity of the client and the server of the DoH provider. Some DoH resolves may use mTLS where the endpoint device 104 presents certificates containing context such as device identify or user roles, which may be used to apply policies based on that context. Thus, there are various mechanisms and protocols which may be used to provide context along with the DNS queries for the policy engine 102 to consider.

Once the endpoint device 104 receives a verdict 124 (e.g., allow, block, proxy, etc.), the endpoint device 104 may perform a networking operation based on the verdict 124. For example, upon receiving an allow verdict 124, the endpoint device 104 may leave any associated connections to the destination 106 domain untouched and route according to the normal routing policies managed by the OS (e.g., send traffic on the “allow” connection). Upon receiving a “block” verdict 124, which may be returned in the form of a failing DNS response to the endpoint device 104, the endpoint device 104 may refrain from allowing the connections to be established with the destination 106 and may terminate existing connections to the destination 106. Further, upon receiving a “proxy” verdict 124, the endpoint device 104 may use a secure overlay 116 session to proxy any associated connections to, for instance, the security proxy for further inspection. In some instances, the proxy verdict 124 may include metadata for selecting a proxy server to enable load balancing or the usage of an on-premises proxy server to access on-premises resources.

It should be noted that the traffic sent via the proxy verdict connection 128 and over the secure overlay 116 may ultimately be routed to one or more of the public network 106A, cloud network(s) 106B, and/or the data center/branch office/colocation facility 106N.

Although techniques of this application are described as being implemented by intercepting DNS queries, in some examples, the techniques may include applying policy using networking layer 3 (IPv4 and IPv6) and layer 4 (TCP and UDP) addresses. When the client sees a new TCP or UDP socket being created, it may similarly query the policy engine 102 for a verdict 124 to allow, block, or proxy the socket connection. In some instances, the policy engine 102 could also apply policy using site categorization such as gambling, personal banking, Generative AI, DLP, Trusted SaaS, etc. An advantage of the techniques described herein is the traffic may be dynamically steered at access time to be forward to the tunnel/proxy or sent out the public interface . . . or just outright blocked at the endpoint device 104.

In some instances, the techniques described herein may include selecting between a fleet of proxies (based on policies) to optimally route traffic to the ideal proxy to service that request. For example, if a private resource is in DC4, the proxy in DC4 (and on-premises virtual firewall appliance, for example) can be used to provide the best path of access for the user, giving an optimal experience. These additional capabilities may include using a shard technique to select which MASQUE proxy session/tunnel (or other proxying or tunneling technology) the traffic should go over. The methodology can either use a mod algorithm or a route-table/mask algorithm. These techniques may include assigning all traffic that had a value of “0” after mod or mask operations to go over the cloud security service MASQUE proxy session/tunnel (or other proxying or tunneling technology). Then a value on “N>0” would be used to steer traffic down one of the other MASQUE proxy sessions/tunnels (or other proxying or tunneling technologies). For example, a synthetic IP address of 127.128.0.0 would go over the cloud security service MASQUE proxy session (tunnel), while a resolved synthetic IP address of 127.128.0.1 would go over the first on-prem Secure Appliance MASQUE proxy session/tunnel (or other proxying or tunneling technology), and so forth, up to the number of total proxy nodes in a given configuration. This allows for dynamic routing not only on the endpoint but also across a fleet of Proxy nodes to optimize the routing of proxied (tunneled) traffic.

Further, the endpoint device 104 may incorporate a mechanism for handling static routing policies. During the establishment of the secure tunnel, the endpoint device 104 may receive static routing policies. These policies can be used in conjunction with the dynamic verdicts 124 received from the policy engine 102. In some cases, the verdict 124 from the policy engine 102 may override the static routing policies, allowing for more flexible and responsive traffic management. The ability to override static routing policies with dynamic verdicts 124 provides a level of adaptability that is crucial in today's rapidly changing network environments. This feature allows organizations to respond quickly to new security threats or changing network conditions without having to update static policies on each endpoint device 104.

The endpoint devices 104 may be any type of computing device configured to communicate as described herein using various communication protocols. For instance, the endpoint devices 104 may be personal user devices (e.g., desktop computers, laptop computers, phones, tablets, wearable devices, entertainment devices such as televisions, etc.), network devices (e.g., servers, routers, switches, access points, etc.), and/or any other type of computing devices. The endpoint devices 104 may include or run one or more processes, such as browsers, applications, agents, VPN clients, and so forth that are able to establish connections/flows between the endpoint devices 104 and the destinations 106 and cloud security service provider 101. For instance, the processes may initiate connections or flows to backend applications or services that are hosted in the destinations 106.

The policy engine 102 may not only use routing policies 118 by a routing policy component 120 to make decisions regarding the verdicts 124, but may further include a DNS component 122. In some instances, the DNS component 122 may be utilized to resolve the DNS request 108 and return an IP address to the endpoint device 104.

Generally, the cloud security service provider 101 and/or destinations 106 may include devices housed or located inside one or more data centers that may be located at different physical locations. For instance, the cloud security service provider 101 and/or destinations 106 may be supported by networks of devices in a public cloud computing platform, a private/enterprise computing platform, and/or any combination thereof. The one or more data centers may be physical facilities or buildings located across geographic areas that designated to store networked devices that are part of the cloud security service provider 101 and/or destinations 106. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples the devices in the cloud security service provider 101 and/or destinations 106 may not be located in explicitly defined data centers, but may be located in other locations or buildings.

The cloud security service provider 101 and/or destinations 106 may be accessible to endpoint devices 104 over one or more networks, such as the Internet or private connections. The networks may each include one or more networks implemented by any viable communication technology, such as wired and/or wireless modalities and/or technologies. The networks may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs) . . . both centralized and/or distributed . . . and/or any combination, permutation, and/or aggregation thereof.

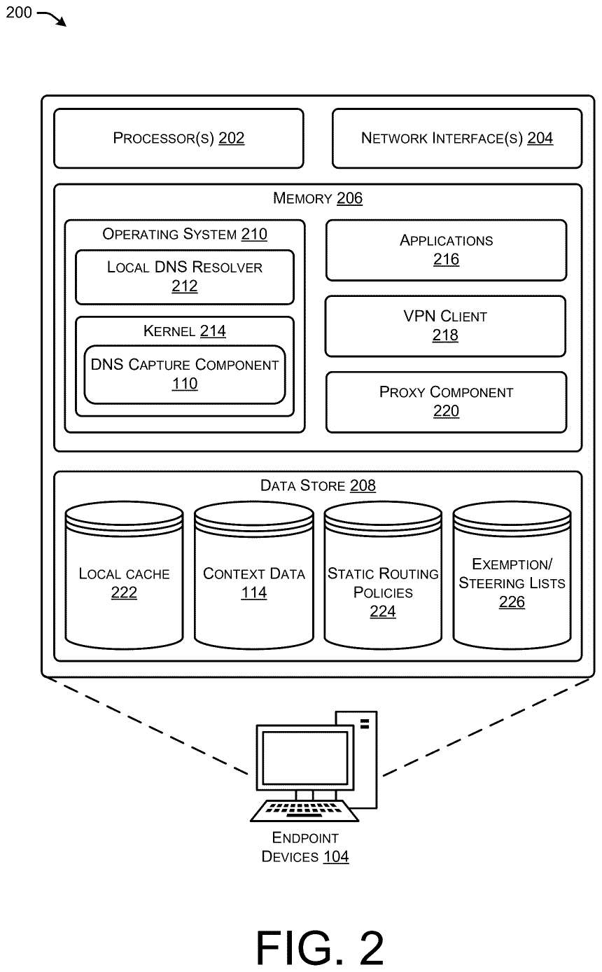

FIG. 2 illustrates a component diagram 200 of example components of an endpoint device 104 as described herein. The component diagram 200 represents a detailed view of the internal components and software modules that may be present in an endpoint device 104 as shown in FIG. 1.

The endpoint device 104 includes a processor 202 and a network interface 204 for handling communications. The processor 202 may be any suitable processing unit capable of executing instructions and performing computations necessary for the operation of the endpoint device 104. The network interface 204 enables the endpoint device 104 to communicate with other devices and networks, including the cloud security service provider 101 and various network destinations 106 shown in FIG. 1.

The endpoint device 104 includes memory 206 that contains several software components. The memory 206 may be any suitable type of computer-readable storage medium capable of storing and retrieving data and instructions. It may include volatile memory (e.g., RAM) and/or non-volatile memory (e.g., ROM, flash memory, etc.). Within the memory 206, an operating system 210 is present. The operating system 210 manages the hardware resources of the endpoint device 104 and provides services for running other software applications. As part of its networking capabilities, the operating system 210 includes a local DNS resolver 212. The local DNS resolver 212 is responsible for resolving domain names to IP addresses, sometimes by querying external DNS servers and sometimes locally.

The operating system 210 also includes a kernel 214, which is the core component of the operating system that manages system resources and provides low-level services to other parts of the system. Within the kernel 214, a DNS capture component 110 is implemented. This component, as described in FIG. 1, is responsible for intercepting DNS requests before they reach the local DNS resolver 212.

The memory 206 also contains various application components including an application module 216, a VPN client 218, and a proxy component 220. The application module 216 may represent any software application running on the endpoint device 104 that generates network traffic. The VPN client 218 is responsible for establishing and maintaining secure VPN connections, which may be used as part of the secure overlay 116 shown in FIG. 1. The proxy component 220 handles the routing of traffic through proxy servers when required by the routing policies or verdicts received from the policy engine 102.

A data store 208 is provided that contains multiple data repositories. The data store 208 may be implemented using any suitable storage technology, such as solid-state drives, hard disk drives, or a combination of different storage technologies. Within the data store 208, several key components are present, such as a local cache 222 for storing DNS-related data, including previously received verdicts from the policy engine 102, and context data 114, which contains system state information that may be sent along with DNS requests to the policy engine 102 for more informed decision-making. Additionally, routing policies may be stored for storing traffic steering rules, which may include both static routing policies 224. These static routing policies 224 may be received at the endpoint device 104 at the time of session establishment and may be utilized in some examples (e.g., connection is lost to the cloud security service provider 101).

An exemption/steering list 226 containing bypass rules that allow certain traffic to bypass the secure overlay 116 and connect directly to destinations. For instance, if a domain in a DNS request is included in the exemption list, then the DNS request may be resolved locally using OS native resolving rather than going to the cloud security service provider 101. Further, if a domain in a DNS request is included in the steering list 226, the local DNS resolver 212 may return a synthetic IP address that already has routing or steering directions.

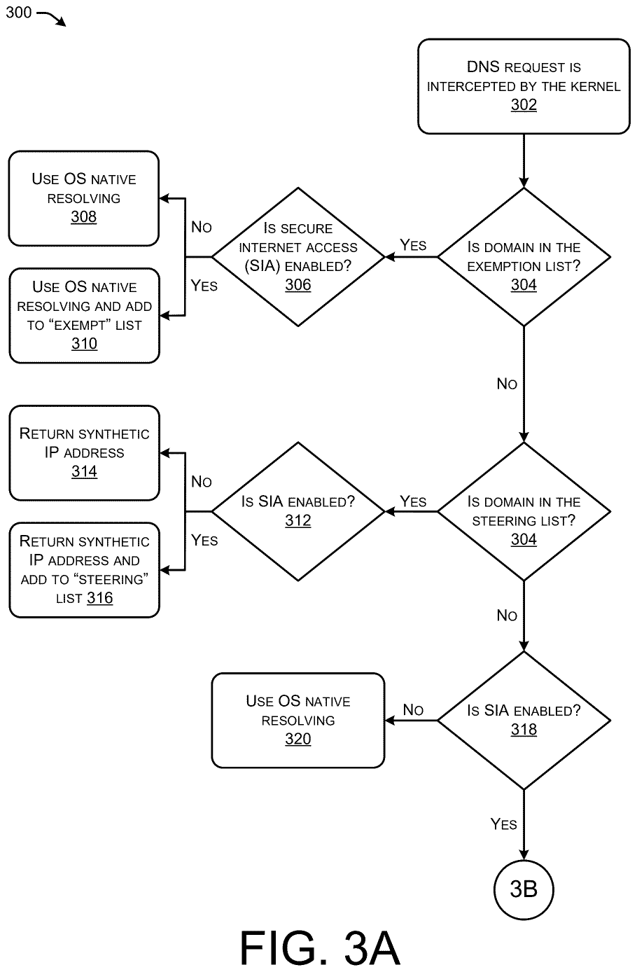

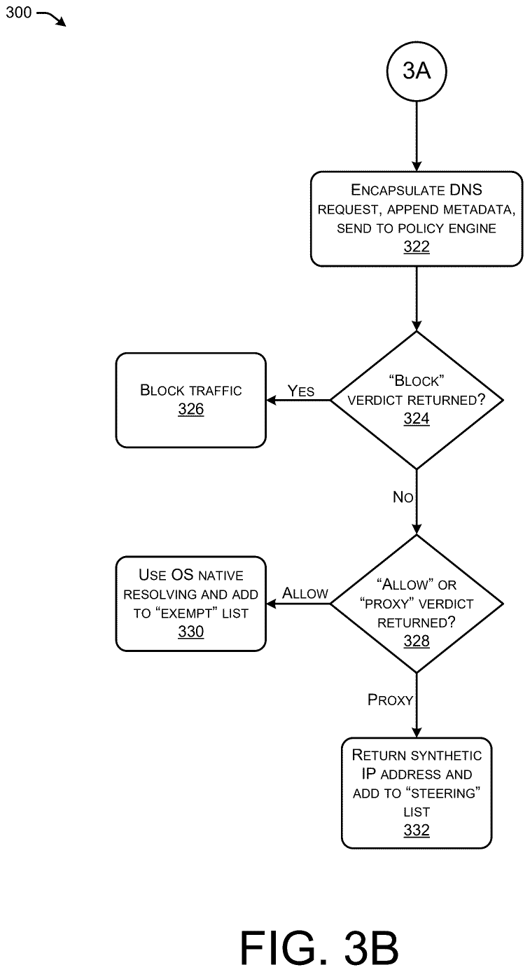

FIGS. 3A and 3B collectively illustrate a sequence diagram of techniques described herein for DNS request capture and performing dynamic policy-based routing of network traffic during session runtime.

The method 300 begins when a DNS request 108 is intercepted by the kernel 214 (e.g., DNS capture component 110) at step 302. This interception occurs before the DNS request 108 reaches the operating system's native DNS resolver, allowing for policy-based decisions to be made. From step 302, the method 300 proceeds to step 304, where a determination is made whether the domain is in the exemption list 226 as shown in FIG. 2. If the domain is in the exemption list (Yes branch), the method 300 proceeds to step 306 to determine if secure internet access (SIA) is enabled.

At step 306, if SIA is enabled (Yes branch), the method 300 moves to step 310 where the OS native resolving is used and the domain is added to the “exempt” list. This allows for direct access to trusted domains without additional security checks. If SIA is not enabled (No branch), the method 300 proceeds to step 308 where OS native resolving is used without modifying the exempt list.

If at step 304 the domain is not in the exemption list (No branch), the method 300 proceeds to determine if the domain is in the steering list at step 304. The steering list may contain domains that require special handling or routing. If the domain is in the steering list (Yes branch), the method proceeds to step 312 to determine if SIA is enabled.

At step 312, if SIA is enabled (Yes branch), the method 300 moves to step 316 where a synthetic IP address is returned and added to the “steering” list. This synthetic IP can be used to trigger specific routing behaviors later in the process. If SIA is not enabled (No branch), the method 300 proceeds to step 314 where a synthetic IP address is returned without modifying the steering list.

If at step 304 the domain is not in the steering list (No branch), the method 300 proceeds to step 318 to determine if SIA is enabled. If SIA is not enabled (No branch), the method 300 moves to step 320 where OS native resolving is used. If SIA is enabled (Yes branch), the method 300 proceeds to entry point 3B, which continues the process in FIG. 3B.

FIG. 3B illustrates a flowchart depicting a portion of method 300 that continues from FIG. 3A. The method proceeds to step 322, where a DNS request is encapsulated with metadata and sent to a policy engine. This encapsulation may include the context data 114 described in FIG. 1 and FIG. 2.

From step 322, the method advances to a decision step 324, which determines if a “block” verdict is returned from the policy engine. If a “block” verdict is returned (Yes branch), the method proceeds to step 326, where traffic is blocked. This prevents any communication with the requested domain.

If a “block” verdict is not returned (No branch), the method moves to another decision step 328, which determines if an “allow” or “proxy” verdict is returned. If an “allow” verdict is returned, the method proceeds to step 330, where OS native resolving is used and the result is added to an “exempt” list. This allows for direct access to the domain in future requests.

Alternatively, at 328 if a “proxy” verdict is returned, the method advances to step 332 where a synthetic IP address is returned and added to a “steering” list. This synthetic IP can be used to apply specific routing policies to the traffic.

The flowchart shows how DNS requests are processed and handled based on different verdict types, with each verdict type resulting in a specific action regarding traffic handling and list management. The method incorporates decision points that determine whether traffic should be blocked, allowed through native OS resolving, or handled using synthetic IP addresses.

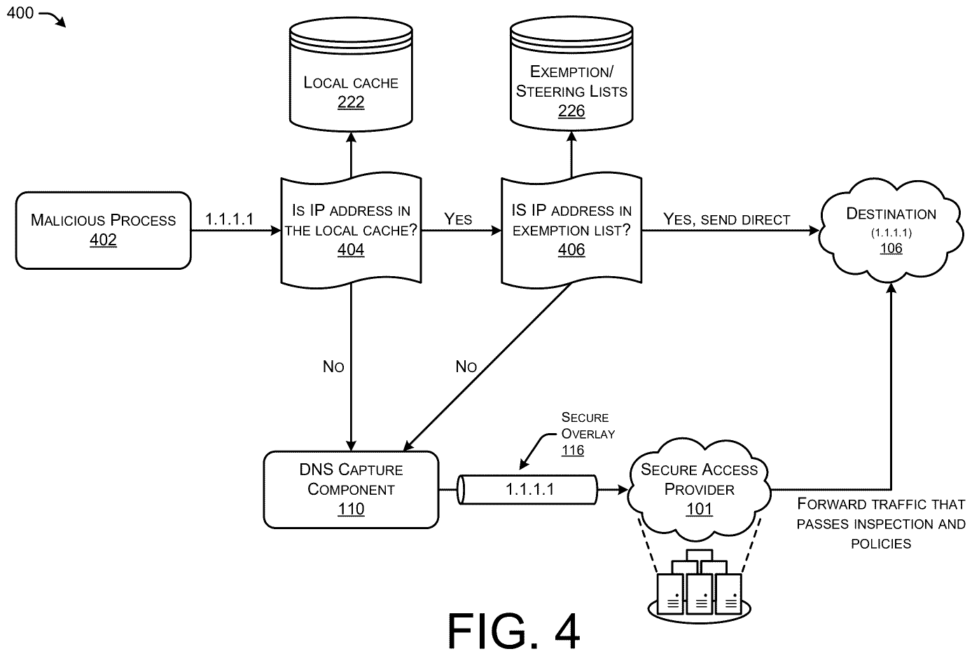

FIG. 4 illustrates a flowchart depicting a method 400 for performing dynamic policy-based routing of network traffic of a malicious process during session runtime.

The method 400 begins with a malicious process 402 attempting to make a connection using an IP address (1.1.1.1). This represents a potential security threat that the system aims to mitigate.

The method 400 proceeds to step 404, where a check is performed to determine if the IP address is present in a local cache 222. The local cache 222 may contain previously made routing decisions for specific IP addresses. If the IP address is found in the local cache 222 (Yes path), the method 400 moves to step 406 to check if the IP address is listed in exemption list 226. If the IP address is found in the exemption list 226 (Yes path), the traffic is sent directly to a destination 106. This allows for trusted destinations to be accessed without additional security checks. If the IP address is not found in either the local cache 222 (No path from step 404) or the exemption list 226 (No path from step 406), the traffic is directed to the DNS capture component 110.

The DNS capture component 110 processes the traffic through a secure overlay 116 to a cloud security service provider 101. The cloud security service provider 101 performs inspection and applies policies to the traffic. This may involve the policy engine 102 making routing decisions based on the traffic characteristics and applicable security policies. Traffic that passes the inspection and policies is then forwarded to the destination 106. This ensures that only traffic that meets the security requirements is allowed to reach its intended destination.

The flowchart shows the decision points and routing paths for handling network traffic, incorporating both cached decisions and real-time policy evaluation through the cloud security service provider 101. This approach allows for efficient handling of known traffic patterns while maintaining the ability to adapt to new threats or changing network conditions.

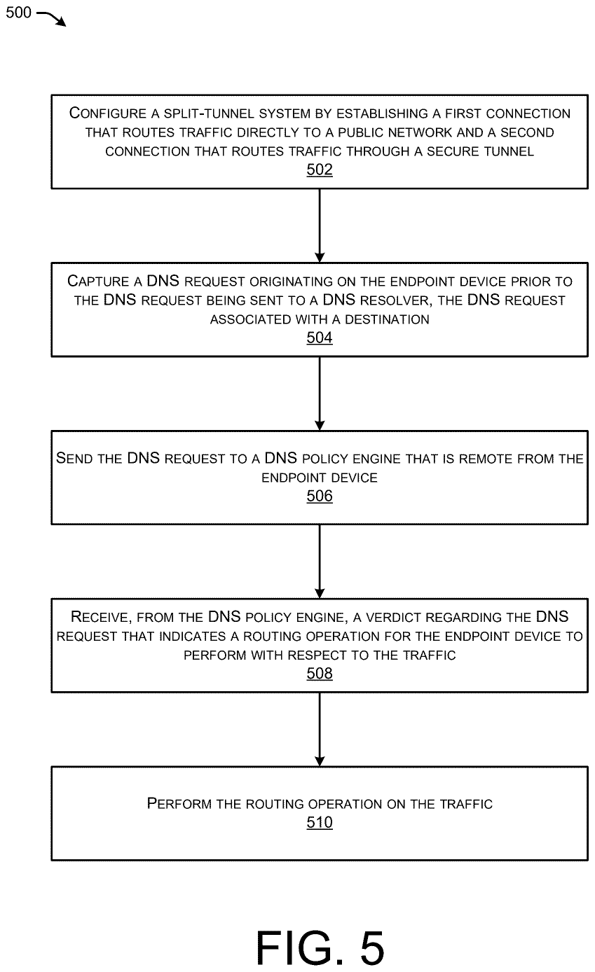

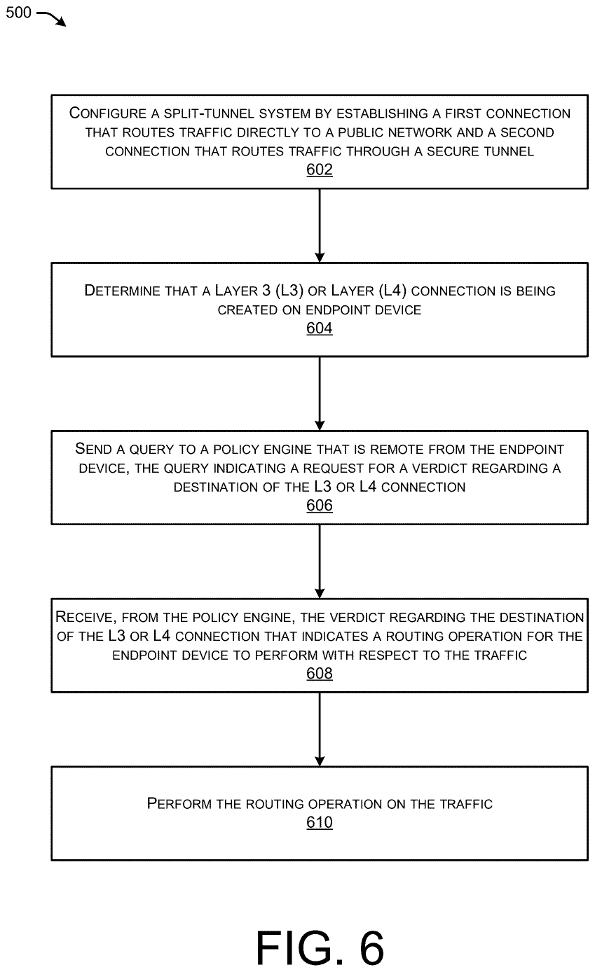

FIGS. 5 and 6 illustrate flow diagrams of example methods 500 and 600 that illustrate aspects of the functions performed at least partly by the devices in the distributed application architecture as described in FIGS. 1-4. The logical operations described herein with respect to FIGS. 5 and 6 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIGS. 5 and 6 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, and/or different arrangements of components.

FIG. 5 illustrates a flow diagram of an example method for intercepting DNS requests to perform dynamic policy-based routing of network traffic during session runtime.

At 502, the endpoint device 104 may configure a split-tunnel system by establishing a first connection that routes traffic directly to a public network 106A and a second connection that routes traffic through a secure overlay 116 (e.g., tunnel). This configuration allows the endpoint device 104 to selectively route traffic based on security requirements and policies. The first connection may be a standard internet connection, while the second connection could be a VPN or other secure overlay network.

At 504, the endpoint device 104 may capture a DNS request 108 originating on the endpoint device before the DNS request is sent to a DNS resolver 212, where the DNS request is associated with a destination 106. This interception is performed by the DNS capture component 110, allowing for policy-based decisions to be made before standard DNS resolution occurs. The capture may occur at the kernel level, ensuring that all DNS requests are intercepted regardless of the application generating them.

At 506, the endpoint device 104 may send the DNS request 108 to a DNS policy engine 102 that is remote from the endpoint device 104. By sending the request to a remote policy engine, the system can leverage centralized, up-to-date security policies and make decisions based on a broader context. The DNS request may be encapsulated with additional context data 114 to aid in policy decisions.

At 508, the endpoint device 104 may receive a verdict 124 from the DNS policy engine 102 regarding the DNS request 108. This verdict indicates a routing operation for the endpoint device to perform with respect to the traffic. The verdict could be “allow,” “block,” or “proxy,” each requiring different handling of the subsequent traffic.

At 510, the endpoint device 104 may perform the routing operation on the traffic based on the received verdict 124. This step ensures that the traffic is handled according to the policy decision. For an “allow” verdict, the traffic may be routed directly through the public network connection. A “block” verdict would result in the traffic being dropped. A “proxy” verdict would route the traffic through the secure tunnel for further inspection or processing.

FIG. 6 illustrates a flow diagram of an example method 600 for identifying L3 or L4 connections being created on an endpoint device and performing dynamic policy-based routing of network traffic during session runtime.

At 602, the endpoint device 104 may configure a split-tunnel system by establishing a first connection that routes traffic directly to a public network 106A and a second connection that routes traffic through a secure overlay 116. This setup is similar to step 502 in FIG. 5, providing the foundation for selective traffic routing. The configuration may involve setting up routing tables and network interfaces to support both direct and tunneled connections.

At 604, the endpoint device 104 may determine that a Layer 3 (L3) or Layer 4 (L4) connection is being created on an endpoint device. This extends the policy-based routing beyond DNS requests to include network and transport layer connections, providing more comprehensive traffic control. The endpoint device 104 may monitor socket creations or network interface activities to detect new connection attempts.

At 606, the endpoint device 104 may send a query to a policy engine 102 that is remote from the endpoint device 104. This query indicates a request for a verdict regarding a destination of the L3 or L4 connection. The query may include context information about the connection, such as the process initiating it, the user context, or the current security posture of the device.

At 608, the endpoint device 104 may receive, from the policy engine 102, the verdict 124 regarding the destination of the L3 or L4 connection. This verdict indicates a routing operation for the endpoint device to perform with respect to the traffic. The verdict may be based on various factors, including the destination IP address, the type of connection, and the context provided in the query.

At 610, the endpoint device 104 may perform the routing operation on the traffic based on the received verdict 124. This final step implements the policy decision, ensuring that the L3 or L4 connection is handled according to the specified routing operation. The endpoint device may modify its routing tables, apply firewall rules, or use other networking mechanisms to enforce the routing decision.

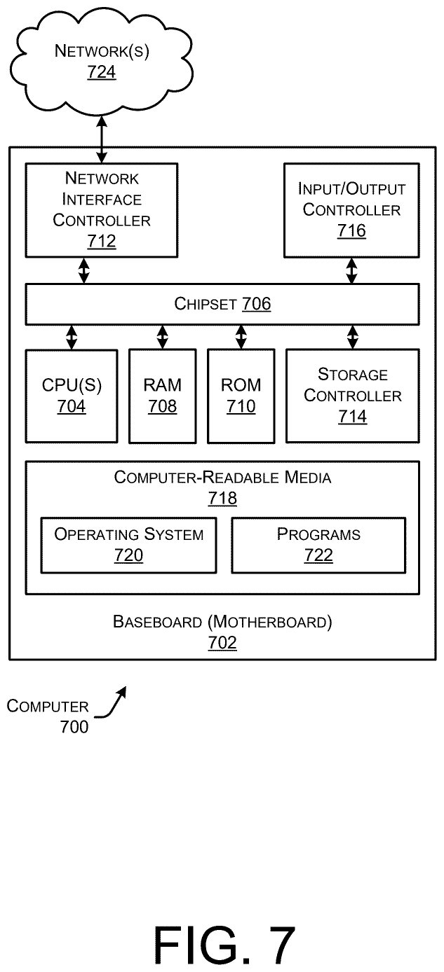

FIG. 7 shows an example computer architecture for a computer 700 capable of executing program components for implementing any of the functionality described above. The computer architecture shown in FIG. 7 illustrates a conventional server computer, workstation, desktop computer, laptop, tablet, network appliance, e-reader, smartphone, or other computing device, and can be utilized to execute any of the software components presented herein. The computer 700 may, in some examples, correspond to a physical server described herein, and may comprise networked devices such as servers, switches, routers, hubs, bridges, gateways, modems, repeaters, access points, etc. In other examples, the computer 700 may be the endpoint device 104, at least part of the policy engine 102, and/or any other device or included in any system described herein. That is, the computer 700 may be any device described herein, or included in any system, and be configured to perform any of the operations described herein.

The computer 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computer 700. The chipset 706 can further provide an interface to a computer-readable storage medium such as a read-only memory (“ROM”) 710 or non-volatile RAM (“NVRAM”) for storing basic routines that help to startup the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network 724. The chipset 706 can include functionality for providing network connectivity through a NIC 712, such as a gigabit Ethernet adapter. The NIC 712 is capable of connecting the computer 700 to other computing devices over a network 724. It should be appreciated that multiple NICs 712 can be present in the computer 700, connecting the computer to other types of networks and remote computer systems.

The computer 700 can be connected to a storage device 718 that provides non-volatile storage for the computer. The storage device 718 can store an operating system 720, programs 722, and data, which have been described in greater detail herein. The storage device 718 can be connected to the computer 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 700 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computer 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 can further read information from the storage device 718 by detecting the physical states or characteristics of one or more particular locations within the physical storage units.

In addition to the mass storage device 718 described above, the computer 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 700. In some examples, the operations performed by the any other device or included in any system described herein, and or any components included therein, may be supported by one or more devices similar to computer 700. Stated otherwise, some or all of the operations performed by any device or included in any system described herein, and or any components included therein, may be performed by one or more computer devices operating in a system arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computer 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computer 700.

In one embodiment, the storage device 718 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes described above with regard to FIGS. 1-6. The computer 700 can also include computer-readable storage media having instructions stored thereupon for performing any of the other computer-implemented operations described herein.

The computer 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

The computer 700 may include one or more hardware processors 704 (processors) configured to execute one or more stored instructions. The processor(s) 704 may comprise one or more cores. Further, the computer 700 may include one or more network interfaces configured to provide communications between the computer 700 and other devices. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth. The programs 722 may comprise any type of programs or processes to perform the techniques described in this disclosure.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. An endpoint device configured to perform dynamic policy-based routing for traffic through a split-tunnel system, the endpoint device comprising:
one or more processors; and
one or more computer-readable media storing computer-executable instructions that, when executed by the one or more processors, cause the one or more processors to perform operations comprising:
configuring the split-tunnel system by establishing a first connection that routes traffic directly to a public network and a second connection that routes traffic through a secure tunnel;
capturing a Domain Name Service (DNS) request originating on the endpoint device prior to the DNS request being sent to a DNS resolver, the DNS request being associated with a destination to which the endpoint device is requesting to send traffic;
sending the DNS request to a DNS policy engine that is remote from the endpoint device;
receiving, from the DNS policy engine, a verdict regarding the DNS request that indicates a routing operation for the endpoint device to perform with respect to the traffic; and
performing the routing operation on the traffic.

2. The endpoint device of claim 1, wherein:
the routing operation indicated by the verdict is for the endpoint device to route the traffic through the secure tunnel using the second connection; and
performing the routing operation includes routing the traffic through the secure tunnel.

3. The endpoint device of claim 1, wherein:
the verdict is included in a failing DNS response that indicates the routing operation is to block the traffic; and
performing the routing operation includes blocking the traffic from being transmitted.

4. The endpoint device of claim 1, the operations further comprising:
receiving, during establishment of the secure tunnel, static routing policies for the secure tunnel,
wherein:
the routing operation indicated by the verdict is for the endpoint device to route the traffic according to the static routing policies; and
performing the routing operation includes routing the traffic directly to the public network using the first connection.

5. The endpoint device of claim 1, the operations further comprising:
receiving, during establishment of the secure tunnel, static routing policies for the secure tunnel,
wherein:
the verdict is to block the traffic or route the traffic directly to the public network using the first connection; and
the verdict is different than a routing decision indicated by the static routing policies.

6. The endpoint device of claim 1, the operations further comprising:
identifying context data associated with the DNS request or the endpoint device; and
appending the context data to the DNS request prior to sending the DNS request to a DNS policy engine,
wherein the verdict is determined by the DNS policy engine based at least in part on the context data.

7. The endpoint device of claim 6, wherein:
the DNS request is sent inside of a Hypertext Transport Protocol (HTTP) request using DNS over HTTP (DOH); and
the context data is embedded within a request payload of the HTTP request.

8. A method performed by an endpoint device configured to perform dynamic policy-based routing for traffic through a split-tunnel system, the method comprising:
configuring the split-tunnel system by establishing a first connection that routes traffic directly to a public network and a second connection that routes traffic through a secure tunnel;
capturing a Domain Name Service (DNS) request originating on the endpoint device prior to the DNS request being sent to a DNS resolver, the DNS request being associated with a destination to which the endpoint device is requesting to send traffic;
sending the DNS request to a DNS policy engine that is remote from the endpoint device;
receiving, from the DNS policy engine, a verdict regarding the DNS request that indicates a routing operation for the endpoint device to perform with respect to the traffic; and
performing the routing operation on the traffic.

9. The method of claim 8, wherein:
the routing operation indicated by the verdict is for the endpoint device to route the traffic through the secure tunnel using the second connection; and
performing the routing operation includes routing the traffic through the secure tunnel.

10. The method of claim 8, wherein:
the verdict is included in a failing DNS response that indicates the routing operation is to block the traffic; and
performing the routing operation includes blocking the traffic from being transmitted.

11. The method of claim 8, further comprising:
receiving, during establishment of the secure tunnel, static routing policies for the secure tunnel,
wherein:
the routing operation indicated by the verdict is for the endpoint device to route the traffic according to the static routing policies; and
performing the routing operation includes routing the traffic directly to the public network using the first connection.

12. The method of claim 8, further comprising:
identifying context data associated with the DNS request or the endpoint device; and
appending the context data to the DNS request prior to sending the DNS request to a DNS policy engine,
wherein the verdict is determined by the DNS policy engine based at least in part on the context data.

13. The method of claim 12, wherein:
the DNS request is sent inside of a Hypertext Transport Protocol (HTTP) request using DNS over HTTP (DOH); and
the context data is embedded within a request payload of the HTTP request.

14. The method of claim 12, wherein:
appending the context data to the DNS request comprises using at least one of an overlay technology or an extension mechanism for DNS (eDNS).

15. The method of claim 12, wherein capturing the DNS request originating on the endpoint device is performed by a kernel component executing in a kernel of the endpoint device.

16. A computer-implemented method comprising:
configuring, at an endpoint device, a split-tunnel system by establishing a first connection that routes traffic directly to a public network and a second connection that routes traffic through a secure tunnel;
determining that a Layer 3 (L3) or Layer (L4) connection is being created on the endpoint device;
sending a query to a policy engine that is remote from the endpoint device, the query indicating a request for a verdict regarding a destination of the L3 or L4 connection;
receiving, from the policy engine, the verdict regarding the destination of the L3 or L4 connection that indicates a routing operation for the endpoint device to perform with respect to the traffic; and
performing the routing operation on the traffic.

17. The computer-implemented method of claim 16, wherein:
the routing operation indicated by the verdict is for the endpoint device to route the traffic through the secure tunnel using the second connection; and
performing the routing operation includes routing the traffic through the secure tunnel.

18. The computer-implemented method of claim 16, wherein:
the verdict indicates the routing operation is to block the traffic; and
performing the routing operation includes allowing the L3 or L4 connection to be established.

19. The computer-implemented method of claim 16, further comprising:
identifying an Internet Protocol (IP) address associated with the L3 or L4 connection,
wherein the query includes an indication of the IP address.

20. The computer-implemented method of claim 16, wherein:
determining that the L3 or L4 connection is being created on the endpoint device includes detecting that an L4 socket is being created on the endpoint device; and
performing the routing operation includes at least one of:
allowing the L3 or L4 connection to be established; or
blocking the L3 or L4 connection.
